(19) United States
(12) Patent Application Publication
(10) Pub. No.: US 2025/0356675 A1
(43) Pub. Date: Nov. 20, 2025

(54) IMAGE PROCESSING APPARATUS

(71) Applicant: KYOCERA Document Solutions Inc., Osaka (JP)

(72) Inventors: Hiroshi SUGIHARA, Osaka (JP); Ryota OKUI, Osaka (JP); Koji SATO, Osaka (JP); Kota KAMISONO, Osaka (JP)

(73) Assignee: KYOCERA Document Solutions Inc., Osaka (JP)

(21) Appl. No.: 19/210,437

(22) Filed: May 16, 2025

(30) Foreign Application Priority Data
May 20, 2024 (JP) 2024-081467

(51) Int. Cl. G06V 30/146; G06V 10/24; G06V 10/25; G06V 10/764; G06V 30/19; G06V 30/413; H04N 1/00

(52) U.S. Cl. CPC G06V 30/147; G06V 10/24; G06V 10/25; G06V 10/764; G06V 30/1463; G06V 30/19173; G06V 30/413; H04N 1/00331; H04N 1/00795; H04N 2201/0081

(57) ABSTRACT

A control portion recognizes, as an independent character region, a region of which the absolute value of the difference between the width in a first direction, which is the writing direction, and the width in a second direction, which is orthogonal to the first direction, is smaller than a first threshold value, and checks, based on the width in the first direction of a reference region that is a character region adjacent, in the second direction, to a plurality of independent character regions aligned in the first direction but that is not an independent character region, whether a character string composed of characters in the plurality of independent character regions is one word. On judging it to be one word, the control portion deals with the character string resulting from uniting the characters in the plurality of independent character regions as one word.

### INCORPORATION BY REFERENCE

This application is based on and claims the benefit of priority from Japanese Patent Application No. 2024-081467 filed on May 20, 2024, the contents of which are hereby incorporated by reference.

### BACKGROUND

The present disclosure relates to image processing apparatuses.

Some known image processing apparatuses read a document and detect a character region out of the image data acquired by reading the document.

### SUMMARY

According to one aspect of the present disclosure, an image processing apparatus includes an image reading portion and a control portion. The image reading portion reads a document containing predetermined information. The control portion performs an OCR process on the image data of the document acquired through the reading by the image reading portion to extract the predetermined information. When extracting the predetermined information, the control portion detects a character region out of the image data, recognizes, as an independent character region, the character region of which the absolute value of the difference between the width in a first direction, which is the writing direction in the image data, and the width in a second direction, which is orthogonal to the first direction, is smaller than a first threshold value previously determined, sets, as a reference region, the character region that is adjacent, in the second direction, to a plurality of independent character regions aligned in the first direction but that is not the independent character region, and checks, based on the width in the first direction of the reference region, whether a character string composed of characters in the plurality of independent character regions aligned in the first direction is one word. On judging that the character string composed of characters in the plurality of independent character regions aligned in the first direction is one word, the control portion unites all the characters in the plurality of independent character regions aligned in the first direction into one character string and deals with the united character string as one word.

### BRIEF DESCRIPTION OF THE DRAWINGS

FIG. 1 is a schematic diagram of a multifunction peripheral according to one embodiment.

FIG. 2 is a block diagram of the multifunction peripheral according to the embodiment.

FIG. 3 is a diagram schematically showing a document that can be the target of reading on the multifunction peripheral according to the embodiment.

FIG. 4 is a flow chart showing a procedure for an information extracting job performed on the multifunction peripheral according to the embodiment.

FIG. 5 is a diagram schematically showing image data generated through reading on the multifunction peripheral according to the embodiment.

FIG. 6 is a diagram showing the positions and the sizes of character regions in the image data generated through reading on the multifunction peripheral according to the embodiment.

### DETAILED DESCRIPTION

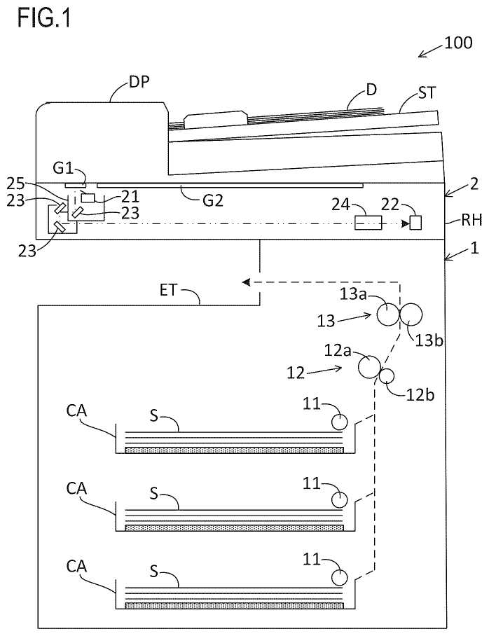

Configuration of a Multifunction Peripheral: With reference to FIGS. 1 to 6, an image processing apparatus according to one embodiment of the present disclosure will be described below taking as an example a multifunction peripheral 100 having a plurality of functions such as scanning, printing, and data transmission.

As shown in FIG. 1, the multifunction peripheral 100 (corresponding to an “image processing apparatus”) includes a printing portion 1. The printing portion 1 constitutes the body of the multifunction peripheral 100. The printing portion 1 prints an image on a sheet S. The printing portion 1 employs an electrophotographic printing process. This however is not meant as any limitation: the printing portion 1 can employ an inkjet printing process.

The printing portion 1 forms an image based on image data fed to the multifunction peripheral 100. The printing portion 1 conveys the sheet S along a sheet conveyance passage. The printing portion 1 prints an image on the sheet S being conveyed. In FIG. 1, the sheet conveyance passage is indicated by a broken line.

The printing portion 1 includes a sheet feed roller 11. The sheet feed roller 11 lies in contact with the sheet S stored in a sheet cassette CA and rotates in that state. Thus, the sheet feed roller 11 feeds the sheet S from the sheet cassette CA to the sheet conveyance passage.

The printing portion 1 includes an image forming portion 12. The image forming portion 12 includes a photosensitive drum 12a and a transfer roller 12b. The photosensitive drum 12a carries a toner image on its circumferential surface. The transfer roller 12b stays in pressed contact with the photosensitive drum 12a and forms a transfer nip with the photosensitive drum 12a. The transfer roller 12b rotates together with the photosensitive drum 12a. The image forming portion 12, while conveying the sheet S having entered the transfer nip, transfers the toner image to the sheet S.

The image forming portion 12 further includes, though not shown, a charging device, an exposure device, and a developing device. The charging device electrostatically charges the circumferential surface of the photosensitive drum 12a. The exposure device forms an electrostatic latent image on the circumferential surface of the photosensitive drum 12a. The developing device develops the electrostatic latent image on the circumferential surface of the photosensitive drum 12a into a toner image.

The printing portion 1 includes a fixing portion 13. The fixing portion 13 includes a heating roller 13a and a pressing roller 13b. The heating roller 13a incorporates a heater (not shown). The pressing roller 13b stays in pressed contact with the heating roller 13a to form a fixing nip with the heating roller 13a. The pressing roller 13b rotates together with the heating roller 13a. The fixing portion 13, while conveying the sheet S having entered the fixing nip, fixes the toner image transferred to the sheet S to the sheet S. The sheet S having left the fixing nip is discharged to a discharge tray ET.

The multifunction peripheral 100 also includes an image reading portion 2. The image reading portion 2 is disposed over the body of the multifunction peripheral 100. In a job involving the reading of a document D, the document D is set on the image reading portion 2. The image reading portion 2 reads the document D set on the image reading portion 2 to generate the image data of the read document D.

The image reading portion 2 includes contact glasses G1 and G2. The contact glasses G1 and G2 are arranged in a housing RH of the image reading portion 2. The housing RH has an opening in its top face. The contact glasses G1 and G2 are fitted in the opening in the top face of the housing RH.

The image reading portion 2 includes a document conveying device DP. The document conveying device DP is fitted to the housing RH. As seen from in front of the multifunction peripheral 100, the document conveying device DP pivots such that a front part of it swings up and down about a rear part of it. The document conveying device DP thus opens and closes with respect to the top face of the housing RH.

The document conveying device DP has a set tray ST on which the document D is set. The document conveying device DP conveys the document D set on the set tray ST onto the contact glass G1.

In a feed-reading mode, the user sets the document D on the set tray ST. The document D automatically conveyed onto the contact glass G1 by the document conveying device DP (in other words, the document D passing over the contact glass G1) is read. On the other hand, in a stationary reading mode, the user sets the document D on the contact glass G2, and the document D on the contact glass G2 is read.

The image reading portion 2 includes a light source 21, an image sensor 22, a mirror 23, and a lens 24. The light source 21, the image sensor 22, the mirror 23, and the lens 24 are arranged inside the housing RH. The image reading portion 2 carries out scanning operation by emitting light from the light source 21 to the contact glass G1 or G2 and performing photoelectric conversion in the image sensor 22.

The light source 21 has a plurality of LED elements. The plurality of LED elements are arrayed in a line along the main scanning direction (the direction perpendicular to the plane of FIG. 1). The image sensor 22 has a plurality of photoelectric conversion elements lined up along the main scanning direction. The mirror 23 reflects light toward the lens 24. The lens 24 collects the light reflected from the mirror 23 and directs it to the image sensor 22.

The light source 21 and the mirror 23 are arranged on a carriage 25 that is movable in the sub (subsidiary) scanning direction (the left-right direction in FIG. 1), which is orthogonal to the main scanning direction. As the carriage 25 moves in the sub scanning direction, the reading line of the image reading portion 2 moves in the sub scanning direction.

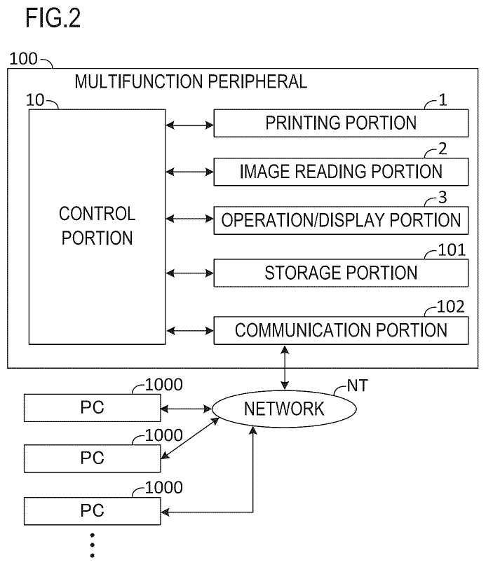

As shown in FIG. 2, the multifunction peripheral 100 includes an operation/display portion 3. The operation/display portion 3 is an operation panel with a touch screen. The operation/display portion 3 displays software buttons, messages, and the like on the touch screen. The operation/display portion 3 also has a plurality of hardware buttons. The operation/display portion 3 accepts operations from the user. Via the operation/display portion 3 the user can make settings on the multifunction peripheral 100 for various jobs including an information extracting process, which will be described later.

The multifunction peripheral 100 includes a control portion 10. The control portion 10 includes a CPU, an ASIC, a memory, and the like. The control portion 10 also includes an image processing circuit. The control portion 10 performs various kinds of image processing on image data. The control portion 10 also controls the printing of an image on the sheet S by the printing portion 1, and controls the reading of the document D by the image reading portion 2.

The control portion 10 also controls the operation/display portion 3. Specifically, the control portion 10 controls display operation on the touch screen. The control portion 10 senses operations on the software buttons and the hardware buttons. Based on the operations that the operation/display portion 3 accepts from the user, the control portion 10 makes settings for a job.

The multifunction peripheral 100 includes a storage portion 101. The storage portion 101 is a non-volatile storage device. Usable as the storage portion 101 is an HDD or an SSD. The storage portion 101 is connected to the control portion 10. The control portion 10 writes information to and reads information from the storage portion 101.

The storage portion 101 previously stores a character recognition program. Based on the character recognition program, the control portion 10 performs a character recognition process such as OCR (optical character recognition). The control portion 10 handles as the target of the character recognition process the image data acquired through the reading of the document D by the image reading portion 2.

The multifunction peripheral 100 includes a communication portion 102. The communication portion 102 is an interface that permits an external device to be connected to the multifunction peripheral 100 so that communication is possible between them. The communication portion 102 includes a communication circuit, a communication memory, a communication connector, and the like. The communication portion 102 is connected to the control portion 10. Using the communication portion 102 the control portion 10 exchanges data with the external device.

The communication portion 102 is connected to the external device across a network NT such as a LAN and the Internet so that communication is possible between them. Though not illustrated, the communication portion 102 can be connected directly to the external device via a communication cable. The external device connected to the communication portion 102 is, for example, a personal computer 1000 (hereinafter “PC 1000”) used by the user of the multifunction peripheral 100. Any external device other than the PC 1000 can be connected to the multifunction peripheral 100 so that communication is possible between them. Connecting the PC 1000 to the multifunction peripheral 100 permits the image data of the document D acquired through the reading of the document D by the image reading portion 2 to be transmitted to the PC 1000. Thus, the image data of the document D can be stored on the PC 1000.

Extraction of the Personal Information: The multifunction peripheral 100 has an information extracting function. In other words, the multifunction peripheral 100 can perform a job related to the information extracting function (hereinafter “information extracting job”). In the information extracting job, the image reading portion 2 reads a document D containing various kinds of information such as personal information. The control portion 10 performs an OCR process on the image data of the document D acquired through the reading of the document D by the image reading portion 2. This permits the control portion 10 to recognize information such as the personal information in the document D.

Using the information extracting function permits one to extract only predetermined information among information contained in the document D. In other words, in the information extracting job, only text data as predetermined information can be extracted from the image data of the document D.

In the information extracting job, for example, the predetermined information extracted from the image data of the document D can be transmitted to the PC 1000 to be displayed or stored on the PC 1000.

In the information extracting job, for example, image processing is also performed on the original image data acquired through the reading of the document D to generate output image data in which a region corresponding to the predetermined information is anonymized. Then an image based on the output image data (i.e., an image in which the predetermined information is anonymized) can be printed on a sheet S. Or the output image data can be transmitted to the PC 1000 to be stored on the PC 1000. The output image data is image data generated from the original image data and is image data in which part of the original image data is modified.

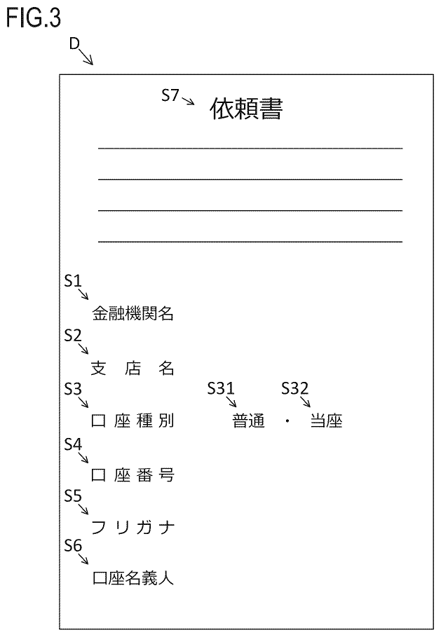

Various documents D can be a possible target of the information extracting job. For example, a document D like the one shown in FIG. 3 can be the target of the information extracting job. FIG. 3 schematically shows, as one example, a document D containing blanks to be filled in with personal information, which is in the following description referred to simply as the document D. The characters on the document D shown in FIG. 3 are Japanese.

The document D generally contains a plurality of sets each comprising the name of an item (item name) along with the value of the item (item value) related to personal information. In the example shown in FIG. 3, character strings S1, S2, S3, S4, S5, and S6 correspond to item names. What follows these item names correspond to item values. In the diagram, no item values corresponding to character strings S1, S2, S4, S5, or S6 as item names respectively are illustrated. The item value corresponding to character string S3 is to be chosen between the item values represented by character strings S31 and S32. Whichever of character strings S31 and S32 is marked (e.g., circled) is the item value corresponding to the item name represented by character string S3. Character string S7 on the document D is the name of the document D.

To perform an information extracting job, the user sets the document D in the image reading portion 2. In this state the user performs on the operation/display portion 3 a starting operation for the information extracting job. When the starting operation is performed on the operation/display portion 3, the control portion 10 starts the information extracting job.

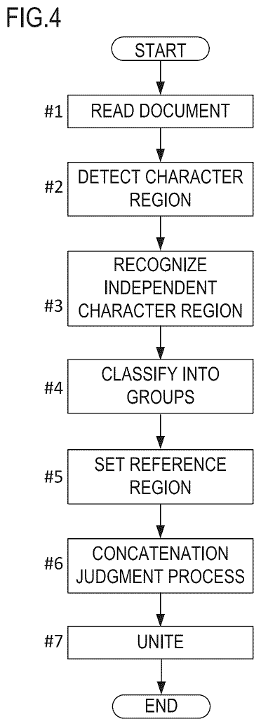

Now, with reference to the flow chart in FIG. 4, the procedure for the information extracting job will be described in detail. The procedure shown in FIG. 4 starts when the starting operation for the information extracting job is performed on the operation/display portion 3. In other words, to extract predetermined information contained in the document D, the control portion 10 follows the procedure shown in FIG. 4.

At step #1, the control portion 10 makes the image reading portion 2 read the document D. The image reading portion 2 reads the document D and generates the image data of the read document D. The image data generated here is original image data. In the following description, the image data of the document D acquired through the reading by the image reading portion 2 is referred to as original image data.

The control portion 10 acquires original image data. The control portion 10 then performs an OCR process on the original image data. As part of the OCR process, the control portion 10 conducts layout analysis, line/character segmentation, and the like. The control portion 10 also recognizes, based on the orientation of characters in the original image data, the writing direction (i.e., the direction in which characters flow) in the original image data.

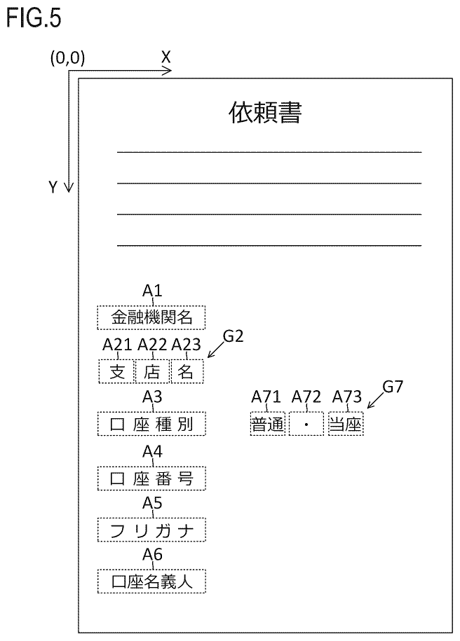

The description continues assuming that the document D shown in FIG. 3 is taken as the target of the information extracting job. With the document D shown in FIG. 3 taken as the target of the information extracting job, the image reading portion 2 reads the document D and thereby generates original image data as shown in FIG. 5. The control portion 10 recognizes, in a coordinate system (screen coordinate system) with its origin (0,0) at the top left corner of the original image data, the positions (i.e., coordinate values) of character regions in the original image data.

In the example shown in FIG. 5, the writing direction is X direction. In other words, X direction corresponds to “first direction” and Y direction orthogonal to X direction corresponds to “second direction.” Though not illustrated, if the writing direction is Y direction, Y direction corresponds to “first direction” and X direction corresponds to “second direction.”

In the following description, the X coordinate value of a character region (which can be an independent character region) corresponds to the coordinate value at one end of the character region in X direction and is, for example, the X coordinate value at the top left corner of the character region. The Y coordinate value of a character region (which can be an independent character region) corresponds to the coordinate value at one end of the character region in Y direction and is, for example, the Y coordinate value at the top left corner of the character region.

At step #2, the control portion 10 detects a character region out of the original image data. In the example shown in FIG. 5, the regions enclosed by broken lines are detected as character region. Generally, out of the original image data, a plurality of character regions are detected. In the following description, the plurality of character regions are identified by the referential signs A1, A21, A22, A23, A3, A4, A5, A6, A71, A72, and A73 respectively wherever distinction is necessary.

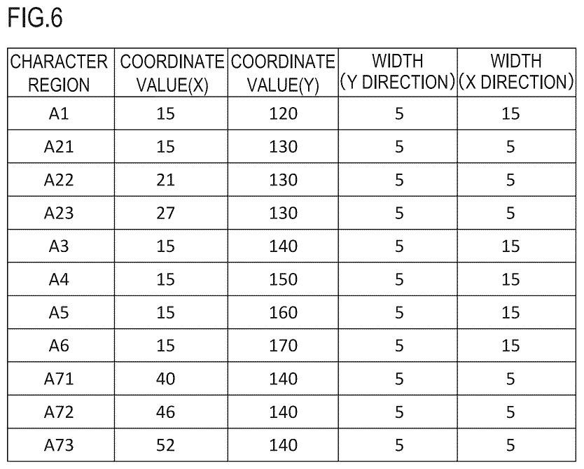

For each of the plurality of character regions, the control portion 10 recognizes its position (coordinate values) in the original image data. In addition, for each of the plurality of character regions, the control portion 10 recognizes its widths in X and Y directions (the latter corresponding to the height of characters). The results are shown in FIG. 6.

At step #3, the control portion 10 checks, for each of the plurality of character regions in the original image data, it is an independent character region. In other words, the control portion 10 recognizes an independent character region in the original image data.

Specifically, for each of the plurality of character regions in the original image data, the control portion 10 calculates the difference between the widths in X and Y directions and recognizes, as an independent character region, a character region of which the absolute value of the difference between the widths in X and Y directions is smaller than a first threshold value previously determined. A character region with substantially the same widths in X and Y directions is recognized as an independent character region. A character region containing one character has substantially the same widths in X and Y directions and thus a character region containing one character is recognized as an independent character region.

For example, in the document D shown in FIG. 3, the plurality of item names are justified at both ends in the writing direction. The first characters in the item names are aligned in their positions in the writing direction and so are the last characters in them. This results in each item name having even character spacing in the writing direction according to the number of the characters in it.

The item names represented by character strings S1 and S6 include the largest number, five, of characters and thus have the smallest character spacing. The item names represented by character strings S3, S4, and S5 include four characters and thus have character spacing slightly larger than for five characters. The item name represented by character string S2 includes as few as three characters and thus has the largest character spacing. In this way, the item names are justified at both ends in the writing direction.

For character strings S31 and S32 following the item name represented by character string S3, for easy marking (circling) by the person filling out, ample spacing is given between character string S31 and “· (bullet)” and between “. (bullet)” and character string S32.

In this example, for each of character strings S1 and S6, the five characters together are detected as one character region. For each of character strings S3, S4, and S5, the four characters together are detected as one character region. That is, out of the original image data, the character regions A1, A3, A4, A5, and A6 are detected.

On the other hand, for character string S2, the three characters constituting character string S2 are detected as separate character regions. The three detected characters are each recognized as an independent character region. That is, the character regions A21, A22, and A23 are character regions each recognized as an independent character region.

Similarly, for the character string following the item name represented by character string S3, character string S31, “. (bullet),” and character string S32 are detected as separate character regions. Then, character string S31, “. (bullet),” and character string S32 are each recognized as an independent character region. That is, the character regions A71, A72, and A73 are character regions each recognized as an independent character region.

Inconveniently, if the three characters in character string S2 as the item name are detected as separate character regions and each character in the three character regions is dealt with as a separate word, character string S2 cannot be recognized as an item name.

To cope with that, in the embodiment, a concatenation judgment process is performed to judge whether to unite characters in a plurality of independent character regions into one character string and to deal with them as one word. Specifically, an advance is made from step #3 to step #4.

At step #4, the control portion 10 divides the plurality of independent character regions in the original image data into groups. The control portion 10 classifies a plurality of independent character regions aligned in a row in X direction into the same group. For such grouping, the control portion 10 recognizes the respective Y coordinate values of the plurality of independent character regions.

For each of the Y coordinate values of the plurality of independent character regions, the control portion 10 compares it with the Y coordinate values of another independent character region to check whether the absolute value of the difference between the two Y coordinate values is smaller than a second threshold value previously determined. In other words, the control portion 10 checks whether the absolute value of the difference between the Y coordinate values of a first and a second independent character regions is smaller than the second threshold value. If the absolute value of the difference between the Y coordinate values of the first and second independent character regions is smaller than the second threshold value, the control portion 10 judges that the first and second independent character regions are aligned in a row in X direction and thus classifies the first and second independent character regions into the same group.

In the example shown in FIG. 5, since all the Y coordinate values of the independent character regions A21, A22, and A23 are “130,” the independent character regions A21, A22, and A23 are classified into the same group. Since all the Y coordinate values of the independent character regions A71, A72, and A73 are “140,” the independent character regions A71, A72, and A73 are classified into the same group. In the following description, the group of the independent character regions A21, A22, and A23 is identified by the reference sign G2 and the group of the independent character regions A71, A72, and A73 is identified by the reference sign G7.

At step #5, for each group, the control portion 10 sets a reference region used to judge whether to unite characters in a plurality of independent character regions in the group (i.e., a plurality of independent character regions aligned in a row in X direction) into one character string. Specifically, the control portion 10 sets, as a reference region, a character region that is adjacent, in Y direction, to a plurality of independent character regions aligned in a row in X direction but that is not an independent character region.

When setting a given target group as a reference region, the control portion 10 sets, as a first reference value, the Y coordinate value of the independent character region with the smallest X coordinate value among the plurality of independent character regions in the target group. Then, for each of the plurality of character regions that are not independent character regions, the control portion 10 sets, as a first difference value, the absolute value of the difference between the Y coordinate value and the first reference value. Then the control portion 10 sets a character region with a first difference value equal to or less than a predetermined value as a candidate for the reference region. If this candidate character region is adjacent, in Y direction, to a plurality of independent character regions in the target group, the control portion 10 sets the candidate character region as the reference region. The predetermined value is, for example, a value a predetermined times (e.g., twice), the width in Y direction of the independent character region with the smallest X coordinate value among the plurality of independent character regions in the target group.

If character regions that are not independent character regions are adjacent to a plurality of independent character regions in the target group from both of one and the other sides along Y direction, the control portion 10 sets, as the reference regions, both of the plurality of character regions that are adjacent, in Y direction, to the plurality of independent character regions in the target group.

In the example shown in FIG. 5, in the setting of the reference region for the target group G2, since the widths in Y direction of the independent character regions A21, A22, and A23 are all “five,” if a predetermined time is twice, the predetermined value is “10 (=5×2).” In addition, since the X coordinate value of the independent character region A21 is the smallest among the independent character regions A21, A22, and A23, the first reference value is “130.”

With attention paid to the character region A1, it has coordinate values of (15,120) and thus its first difference value is “10 (=130−120),” that is, equal to or less than the predetermined value. Likewise, with attention paid to the character region A3, it has coordinate values of (15,140) and thus its first difference value is “10 (=140−130),” that is, equal to or less than the predetermined value. The other character regions have first difference values larger than the predetermined value. Thus, the character regions A1 and A3 are set as the reference regions of the group G2.

As the case may be, a reference region is optionally added. Specifically, when a reference region is set for a given target group, the control portion 10 sets, as a second reference value, the absolute value of the difference between the Y coordinate value of the set reference region and the first reference value. The control portion 10 also sets, as a second difference value, the absolute value of the difference between the Y coordinate value of a character region that is adjacent to the set reference region in Y direction and that is not an independent character region and the Y coordinate value of the set reference region. Then the control portion 10 sets, as an additional reference region, the character region with an absolute value of the difference between the second difference value and the second reference value that is equal to or less than a predetermined value (e.g., the same value as the predetermined value mentioned above).

In the example shown in FIG. 5, with attention paid to the character region A3 as the reference region, it has coordinate values of (15,140) and thus its second reference value is “10 (=140-130).” In addition, the character region A3 as the reference region is adjacent to the character region A4 in Y direction. The character region A4 has coordinate values of (15,150) and thus its second difference value is “10 (=140-130),” which is the same as the second reference value. That is, the absolute value of the difference between the second difference value and the second reference value is equal to or less than the predetermined value.

Thus, the character region A4 too is set as the reference region of the group G2.

If the character region A4 is set as the reference region, the character region A5 adjacent to the character region A4 in Y direction can also be set as the reference region as long as it satisfies a condition for it to be set as the reference region. If the character region A5 is set as a reference region, the character region A6 adjacent to the character region A5 in Y direction can also be set as a reference region as long as it satisfies a condition for it to be set as the reference region. Though not described in detail, in the example shown in FIG. 5, the character regions A5 and A6 are also set as reference regions of the group G2.

In the group G7, no character region is adjacent to the independent character regions A71, A72, and A73 in Y direction, and thus no reference region is set for the group G7. Thus, no concatenation judgment and no uniting is carried out for the independent character regions A71, A72, and A73.

At step #6, the control portion 10 performs a concatenation judgment process for each group. The control portion 10 judges whether to unite characters of a plurality of independent character regions in the same group (i.e., a plurality of independent character regions aligned in a row in X direction) into one character string. In other words, the control portion 10 judges whether to deal with, as one word, the character string composed of characters in a plurality of independent character regions in the same group.

When performing a concatenation judgment process on a given target group, the control portion 10 recognizes the width in X direction of the reference region assigned to the target group. Based on the width in X direction of the reference region, the control portion 10 checks whether the character string composed of characters in a plurality of independent character regions in the target group is one word.

Specifically, the coordinate values of one and the other ends in X direction (e.g., top left and top right corners) of the reference region assigned to the target group are recognized. Then, when each of the X coordinate values of a plurality of independent character regions in the target group is within the range between the coordinate values of one and the other ends in X direction of the reference region, the control portion 10 judges that the character string composed of characters in a plurality of independent character regions in the target group is one word.

If a plurality of reference regions are assigned to a target group, the control portion 10 recognizes the coordinate values of one and the other ends in X direction of the largest reference region that is the longest in X direction among the plurality of reference regions. Then, if the X coordinate values of all of the plurality of independent character regions in the target group are within the range between the coordinate values of one and the other ends in X direction of the largest reference region, the control portion 10 judges that the character string composed of characters in a plurality of independent character regions in the target group is one word.

In the example shown in FIG. 5, the independent character regions A21, A22, and A23 in the group G2 are the target of the concatenation judgment process. The group G2 is assigned a plurality of reference regions (i.e., the character regions A1, A3, A4, A5, and A6). The widths in X direction of the character regions A1, A3, A4, A5, and A6 as the reference regions are all “15” and their X coordinate values are all “15.” Thus, the coordinate value of one end in X direction of the largest reference region is “15” and the coordinate value of the other end is “30 (=15+15).”

In addition, the X coordinate values of the independent character regions A21, A22, and A23 are “15,” “21,” and “27” respectively. That is, the X coordinate values of the independent character regions A21, A22, and A23 are within the range between the coordinate values of one and the other ends in X direction of the largest reference region. Thus, the character string composed of characters in the independent character regions A21, A22, and A23 is judged to be one word.

At step #7, on judging that the character string composed of characters in a plurality of independent character regions in the same group is one word, the control portion 10 unites all the characters in the plurality of independent character regions into one character string. Then, the control portion 10 deals with the united character string as one word.

In the example shown in FIG. 5, a process is carried out to unite all the characters in the independent character regions A21, A22, and A23 in the group G2 into one character string. Then, the character string resulting from uniting in the process is dealt with as one word.

In the embodiment, as described above, the control portion 10 performs a concatenation judgment process on each group. On judging that the character string composed of characters in a plurality of independent character regions in the target group of the concatenation judgment process is one word, the control portion 10 unites all the characters in the plurality of independent character regions in the target group into one character string to deal with the united character string as one word.

This helps prevent a plurality of characters constituting one word from being recognized each as an independent word. Thus, it is possible to accurately extract predetermined information out of the original image data. For example, when extracting as predetermined information an item value corresponding to character string S2 as an item name, it is possible to prevent failure to extract character string S2 as the item name. It is thus possible to prevent the inconvenience of inability to extract the item value corresponding to character string S2 as the item name.

In addition, in the embodiment, a plurality of independent character regions are divided into groups based on Y coordinate values. This configuration reliably allows a plurality of independent character regions aligned in a row in X direction to be classified into the same group. In other words, this prevents a plurality of independent character regions unrelating to each other from being classified into the same group.

Further, in the embodiment, based on the width in X direction (writing direction) of a reference region, it is checked whether a character string composed of characters of a plurality of independent character regions in the same group is one word. This allows an accurate concatenation judgment process if a document D in which a plurality of item names are justified at both ends is the target of an information extraction job.

Still further, in the embodiment, a reference region is set based on Y coordinate values. This configuration prevents setting, as a reference region, of a character region far apart from an independent character region in Y direction (i.e., an unrelated character region).

Still further, in the embodiment, based on the width in X direction of the largest reference region among a plurality of reference regions, it is checked whether a character string composed of characters in a plurality of independent character regions in the same group is one word. For example, if a concatenation judgment process is carried out based on the range of a reference region with a narrow width in X direction, an independent character region at an end can be out of the range of the reference region and thus a character string composed of characters in a plurality of independent character regions may not be judged as one word, which is inconvenient. This leads to poor accuracy of the concatenation judgment process. Thus, the concatenation judgment process is preferably carried out based on the range of the largest reference region among a plurality of reference regions.

The embodiment disclosed herein should be understood to be in every aspect illustrative and not restrictive. The scope of the present disclosure is defined not by the description of the embodiment given above but by the appended claims and encompasses any modifications made within a scope equivalent in significance to those claims.

What is claimed is:

1. An image processing apparatus comprising:
an image reading portion that reads a document containing predetermined information; and
a control portion that performs an OCR process on image data of the document acquired through reading by the image reading portion to extract the predetermined information,
wherein
when extracting the predetermined information, the control portion detects a character region out of the image data,
recognizes, as an independent character region, the character region of which an absolute value of a difference between a width in a first direction, which is a writing direction in the image data, and a width in a second direction, which is orthogonal to the first direction, is smaller than a first threshold value previously determined,
sets, as a reference region, the character region that is adjacent, in the second direction, to a plurality of the independent character regions aligned in the first direction but that is not the independent character region, and
checks, based on a width in the first direction of the reference region, whether a character string composed of characters in the plurality of the independent character regions aligned in the first direction is one word, and
on judging that the character string composed of characters in the plurality of the independent character regions aligned in the first direction is one word, the control portion unites all the characters in the plurality of the independent character regions aligned in the first direction into one character string and deals the united character string as one word.

2. The image processing apparatus according to claim 1, wherein
if an absolute value of a difference between coordinate values at one ends in the second direction of first and second independent character regions is smaller than a second threshold value previously determined, the control portion judges that the first and the second independent character regions are aligned in the first direction and thus classifies the first and the second independent character regions into a same group, and
for each group, the control portion sets the reference region and checks whether a character string composed of characters in the plurality of the independent character regions aligned in the first direction is one word.

3. The image processing apparatus according to claim 1, wherein
the control portion recognizes coordinate values at one and other ends in the first direction of the reference region, and
when the coordinate values at one ends in the first direction of all the plurality of the independent character regions aligned in the first direction are within a range between coordinate values of the one and the other ends in the first direction of the reference region, the control portion judges that a character string composed of characters in the plurality of the independent character regions aligned in the first direction is one word.

4. The image processing apparatus according to claim 1, wherein
the control portion
sets, as a first reference value, a coordinate value at one end in the second direction of the independent character region with a smallest coordinate value at one end in the first direction among the plurality of the independent character regions aligned in the first direction,
sets, for each of a plurality of the character regions that are not the independent character regions, as a first difference value, an absolute value of a difference between the coordinate value at the one end in the second direction and the first reference value, and
sets, as the reference region, the character region with the first difference value equal to or less than a predetermined value.

5. The image processing apparatus according to claim 4, wherein
the predetermined value is a value a predetermined times a width in the second direction of the independent character region with the smallest coordinate value at one end in the first direction among the plurality of independent character regions aligned in the first direction.

6. The image processing apparatus according to claim 4, wherein
the control portion
sets, as a second reference value, an absolute value of a difference of a coordinate value at one end in the second direction of the reference region and the first reference value,
sets, as a second difference value, an absolute value of a difference between a coordinate value at one end in the second direction of the character region that is adjacent to the reference region in the second direction but that is not the independent character region and a coordinate value at one end in the second direction of the reference region, and
further sets, as the reference region, the character region with, as an absolute value of a difference between the second difference value and the second reference value, a value equal to or less than a predetermined value,
if a plurality of the reference regions are set, the control portion recognizes coordinate values of one and other ends in the first direction of a largest reference region that is the longest in the first direction among the plurality of the reference regions, and
if positions in the first direction of all of the plurality of the independent character regions aligned in the first direction are within a range between positions of the one and the other ends in the first direction of the largest reference region, the control portion judges that a character string composed of characters in the plurality of the independent character regions aligned in the first direction is one word.

7. The image processing apparatus according to claim 1, wherein
if the character regions that are not independent character regions are adjacent to the plurality of the independent character regions aligned in the first direction from both of one and other sides along the second direction, the control portion sets, as the reference regions, both of the plurality of the character regions that are adjacent, in the second direction, to the plurality of the independent character regions aligned in the first direction,
if a plurality of reference regions are set, the control portion recognizes coordinate values of one and other ends in the first direction of the largest reference region that is the longest in the first direction among the plurality of the reference regions, and
if positions in the first direction of all of the plurality of the independent character regions aligned in the first direction are within a range between positions of the one and the other ends in the first direction of the largest reference region, the control portion judges that a character string composed of characters in the plurality of the independent character regions aligned in the first direction is one word.
